(19) United States
(12) Patent Application Publication
(10) Pub. No.: US 2008/0084477 A1
(43) Pub. Date: Apr. 10, 2008

(54) Image transmission device and system

(76) Inventor: Timothy C. Crouse, Murray, KY (US)

Correspondence Address: HARSHAW RESEARCH, INC., 210 W. TECUMSEH STREET, OTTAWA, KS, 66067, US

(21) Appl. No.: 11/251,518

(22) Filed: Oct. 14, 2005

(51) Int. Cl. H04N 5/225; H04N 9/04

(52) U.S. Cl. 348/207.99

(57) ABSTRACT

An image transmission device and system includes an image transmission device for use with a user-supplied communications and camera devices and a converter for use with another communications device and display. The image transmission device includes a cradle for respectively securing a cellular phone and camera and circuitry for electrically connecting the two. Images recorded by the camera are compressed by cradle circuitry and transmitted with the phone to a second phone remote from the first. The cradle includes mechanisms for holding phones of various configurations and for being mounted to a tripod. The system further includes a converter device for connection to the second phone and adapted to transmit the images to a display such as a television or to a recording device. Therefore, the image transmission system enables a live event to be transmitted to a remote location for real time viewing by another user.

### BACKGROUND OF THE INVENTION

This invention relates generally to an image transmission device and system. In particular, the present invention relates to a device that integrates video recording equipment and a cellular telephone for transmitting live or recorded video and pictures to a remote location for viewing.

Video recorders and digital cameras are very popular for recording important events so that they may be viewed again and again at later times. For example, video recorders may be used to record a child's athletic events for later viewing by friends and family. The disadvantage of recording the event for later viewing, of course, is that those individuals must in fact wait until a later date—potentially much later—to see it. In other words, there is no convenient means for viewing the event immediately without actually attending the event.

Various proposals have been made in the prior art for transmitting video or other digital data using cellular telephone technology. Although assumably effective for their intended purposes, the existing proposals do not provide a user-friendly device and system for integrating a video camera with a mobile communications device for on-the-spot transmission of a live event and transmitting it to a remote location for immediate viewing on a display.

Therefore, it would be desirable to have an image transmission device and system that is mobile and that directly integrates a video camera and a cellular telephone for transmission of digital images to a remote location for viewing. Further, it would be desirable to have an image transmission device and system that may be mounted to a traditional camera tripod and that may securely hold and connect to a user-supplied cell phone and camera.

### SUMMARY OF THE INVENTION

An image transmission device and system according to the present invention includes an image transmission device and a converter device that may be located remote from the image transmission device. The image transmission device includes a cradle adapted to secure a user-supplied communications device and to attach to a user-supplied video camera. The cradle includes circuitry for electrically connecting a data output port of the digital camera to a data input port of the communications device. The entire cradle may also be mounted to a camera tripod and may include an internal power source or be connected to an external power source for selectively recharging the batteries of the camera and communications device.

The converter is a unit for use with another communications device for receiving images being recorded by the camera at a live event and transmitted by the first communications device. The converter may be connected to a display for displaying the images in real time or for recording the images for later viewing.

Therefore, a general object of this invention is to provide an image transmission device and system for integrating a user-supplied camera with a user-supplied communications device.

Another object of this invention is to provide an image transmission device and system, as aforesaid, having a cradle for securing the communications device and camera and which provides circuitry for electrically connecting said devices.

Still another object of this invention is to provide an image transmission device and system, as aforesaid, which compresses data received from the camera prior to transmitting the data using the communications device.

Yet another object of this invention is to provide an image transmission device and system, as aforesaid, in which the cradle may be mounted to a traditional camera tripod for user-friendly usage.

Another object of this invention is to provide an image transmission device and system, as aforesaid, in which the cradle includes a battery for selectively recharging the communications device or camera in use.

A further object of this invention is to provide an image transmission device and system, as aforesaid, having a converter for use with another communications device at a location remote from the cradle.

A still further object of this invention is to provide an image transmission device and system, as aforesaid, in which the converter may decompress images received by the communications device and deliver them to a display device for immediate or recorded viewing by a person not at a live event.

Other objects and advantages of the present invention will become apparent from the following description taken in connection with the accompanying drawings, wherein is set forth by way of illustration and example, an embodiment of this invention.

### BRIEF DESCRIPTION OF THE DRAWINGS

FIG. 1 is a perspective view of an image transmission device according to the present invention in use with a user-supplied communications device and video camera;

FIG. 2 is a perspective view from another angle of the image transmission device as in FIG. 1;

FIG. 3 is an exploded view of the image transmission device as in FIG. 1;

FIG. 4A is a perspective view of a converter according to the present invention in use with another communications device and a display;

FIG. 4B is a fragmentary view on an enlarged scale of the converter and communications device as in FIG. 4A;

FIG. 5 is a perspective view on an enlarged scale of the image transmission device as in FIG. 1 with the communications device and camera removed;

FIG. 6A is a front perspective view on an enlarged scale of the converter as in FIG. 4B; and

FIG. 6B is a rear perspective view of the converter as in FIG. 4A.

FIG. 7 is a flowchart of the image transmission functionality;

FIG. 8 is a block diagram of the transmission device circuitry;

FIG. 9 is a block diagram of an image transmission device power source connected to respective power input ports of a camera and communications device; and

FIG. 10 is a block diagram of the converter circuitry.

### DESCRIPTION OF THE PREFERRED EMBODIMENT

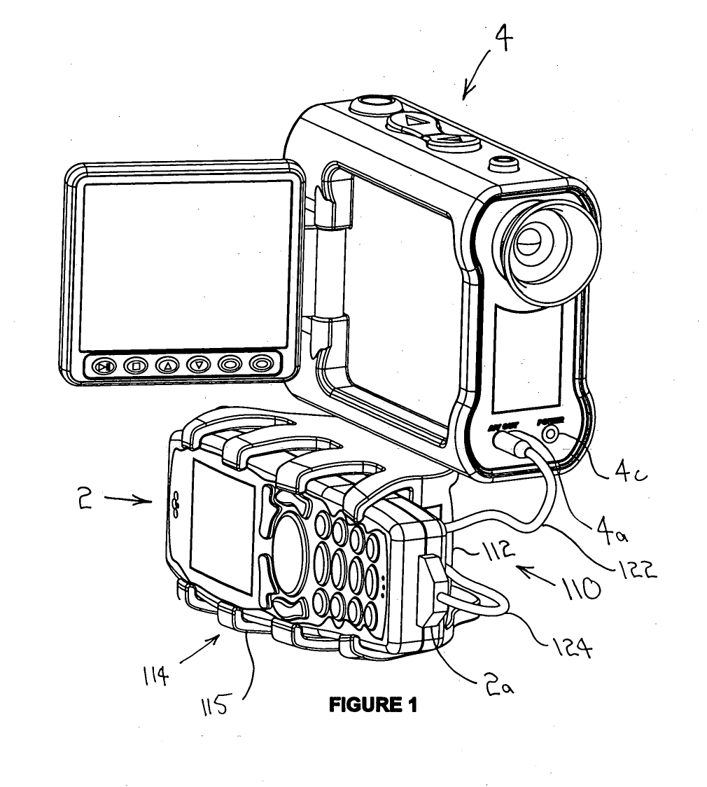

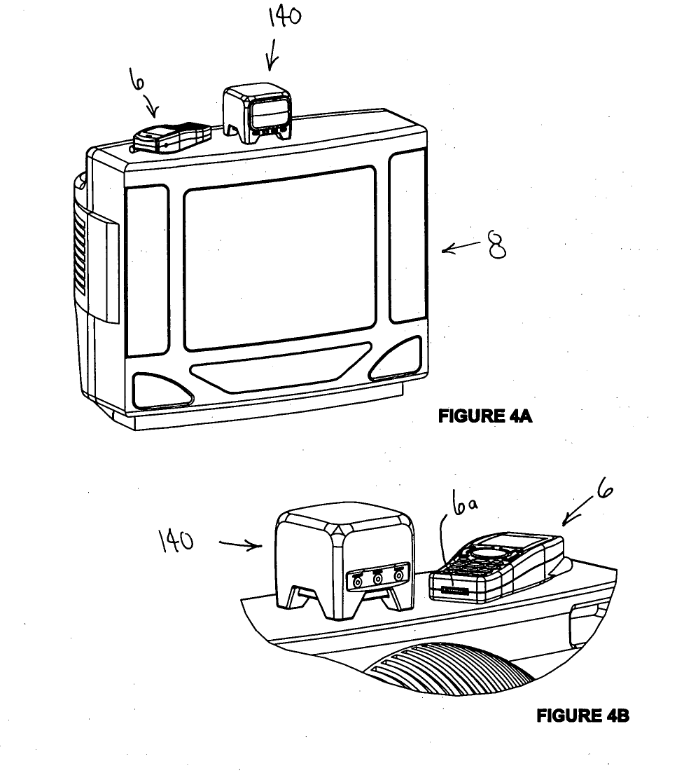

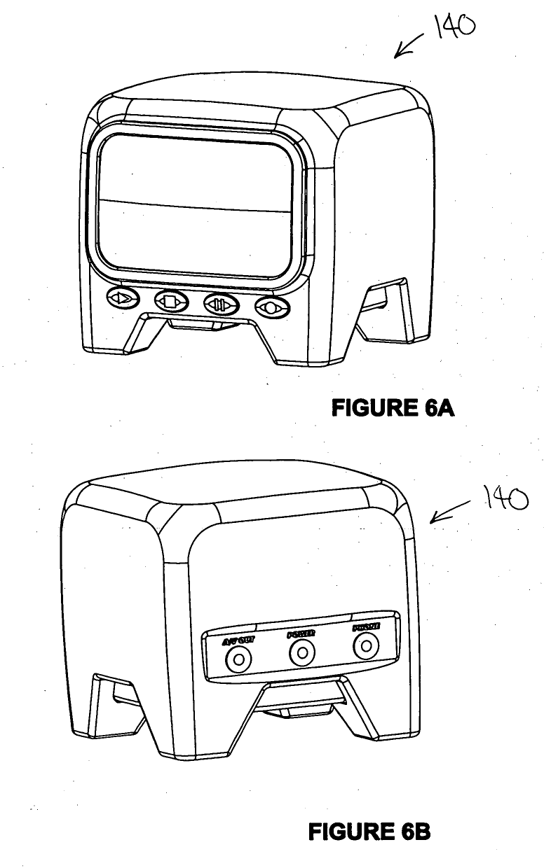

An image transmission device and system according to the present invention will now be described in detail with reference to FIGS. 1 through 7 of the accompanying drawings. More particularly, an image transmission system according to the present invention includes an image transmission device 110 for use with a user-supplied first communications device 2 and a user-supplied camera 4 (FIG. 1), and includes a converter 140 for use with a second user-supplied communications device 6 and a user-supplied display 8 (FIG. 4A). The camera 4 may be a video recorder or may digitally capture still images. The first and second communications devices 2, 6 are preferably cellular telephones, though other communications devices may be used, such as pagers, two-way radios, and the like.

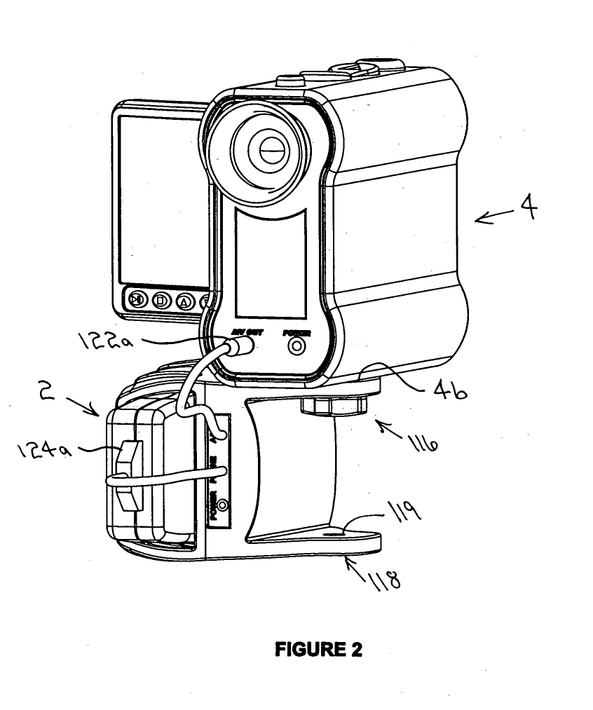

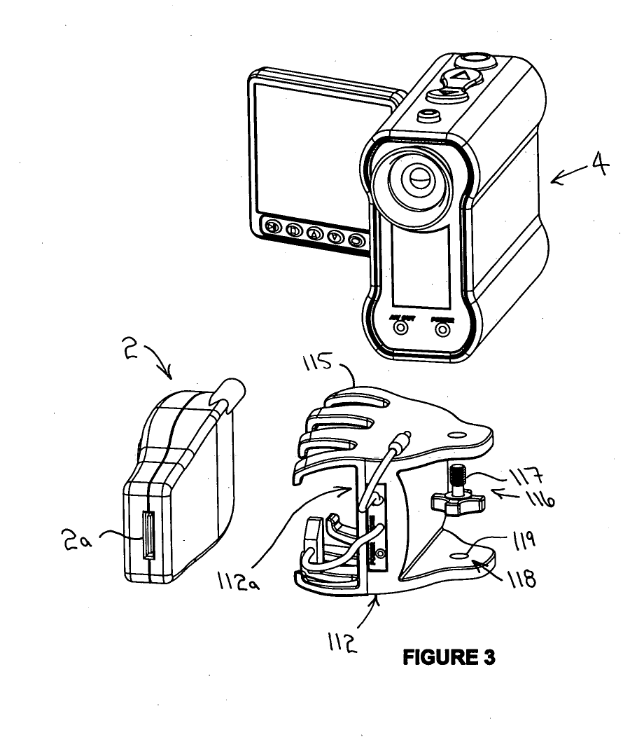

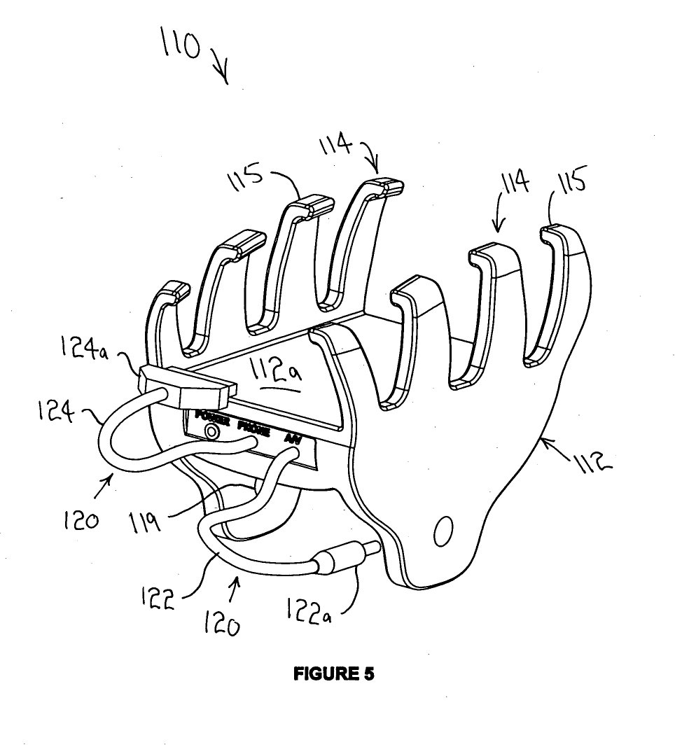

With specific reference to FIG. 5, the image transmission device 110 includes a cradle 112 having a first area 112a for receiving the first communications device 2 and means 114 for securing the first communications device 2 to the cradle first area 112a. As shown in FIGS. 2 and 3, the securing means 114 preferably includes a plurality of oppositely disposed walls 115 being inwardly-biased for securing respective communications devices 2 of various sizes.

An attachment mechanism 116 is preferably connected to the cradle 112 for releasably attaching the cradle 112 to the camera 4. More particularly, the camera 4 preferably defines a threaded opening 4b, and the attachment mechanism 116 is preferably a threaded bolt 117 having a configuration complementary to a configuration of the camera threaded opening 4b.

A second attachment mechanism 118 is preferably connected to the cradle 112 for releasably attaching the cradle 112 to a tripod (the tripod is not shown). In a preferred embodiment, the cradle 112 defines an opening 119 having a configuration complementary to a configuration of a tripod attachment bolt (not shown) for releasably attaching the cradle 112 to the user-supplied tripod. Other attachment mechanisms 118, such as clips and connectors, for example, may also be used.

With particular reference to FIGS. 1 and 5, the image transmission device 110 includes circuitry 120 to selectively connect a data output port 4a of the camera 4 to a data input port 2a of the first communications device 2 for transferring data from the camera 4 to the communications device 2. The circuitry 120 preferably includes first and second electrical cords 122, 124. The first electrical cord 122 extends from the cradle 112 and has a connector 122a compatible with the camera output port 4a; the second electrical cord 124 extends from the cradle 112 and has a connector 124a compatible with the communications device data input port 2a.

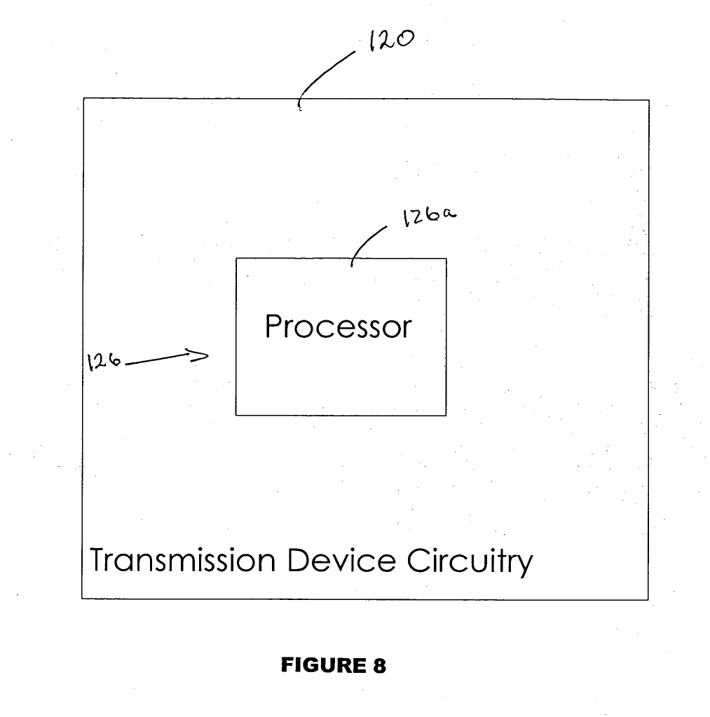

As detailed in FIG. 8, means 126 for compressing the data transferred from the camera 4 to the first communications device 2 may be housed in the cradle 112. The means 126 preferably include a processor 126a housed inside the cradle 112 and electrically connected to the circuitry 120. The processor 126a includes software for compressing the data transferred from the camera data output port 4a and transferring the compressed data to the communications device data input port 2a.

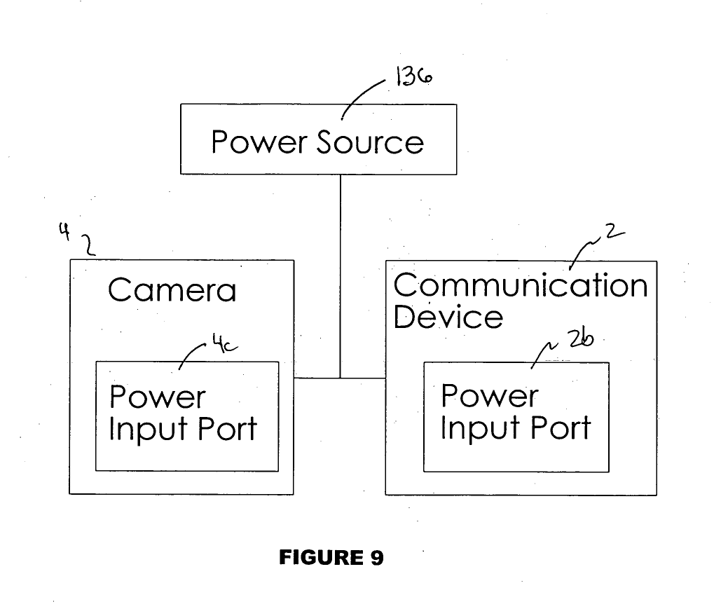

Additional circuitry 130 may be included in the image transmission device 110 (FIG. 9). The additional circuitry 130 is preferably in selective communication with a power source 136, a power input port 4c of the camera 4, and a power input port 2b of the first communications device 2 for selectively powering the first communications device 2 and the camera 4, respectively. The power source 136 may be a battery positioned in the cradle 112, or the power source 136 may be conventional AC current.

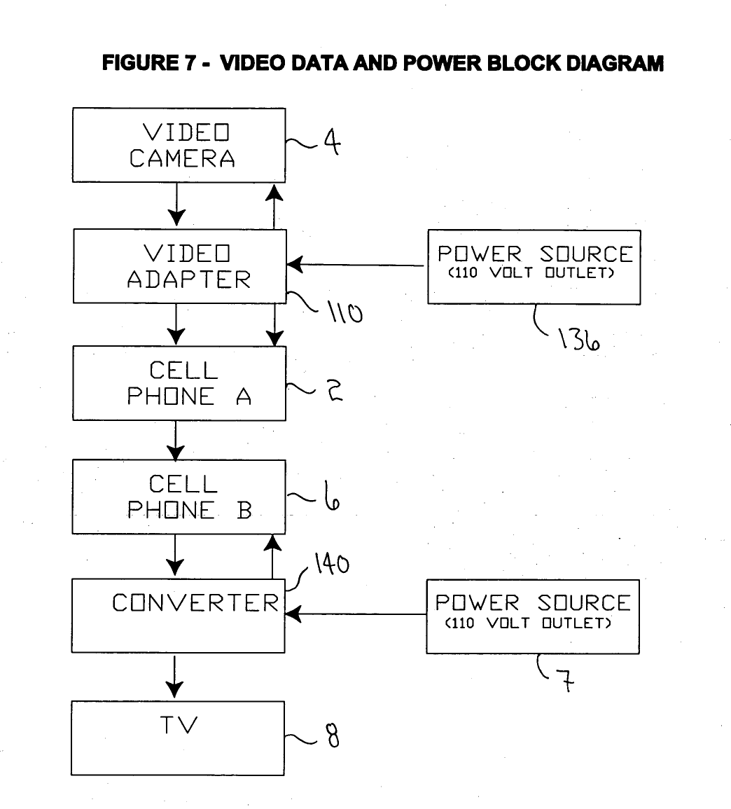

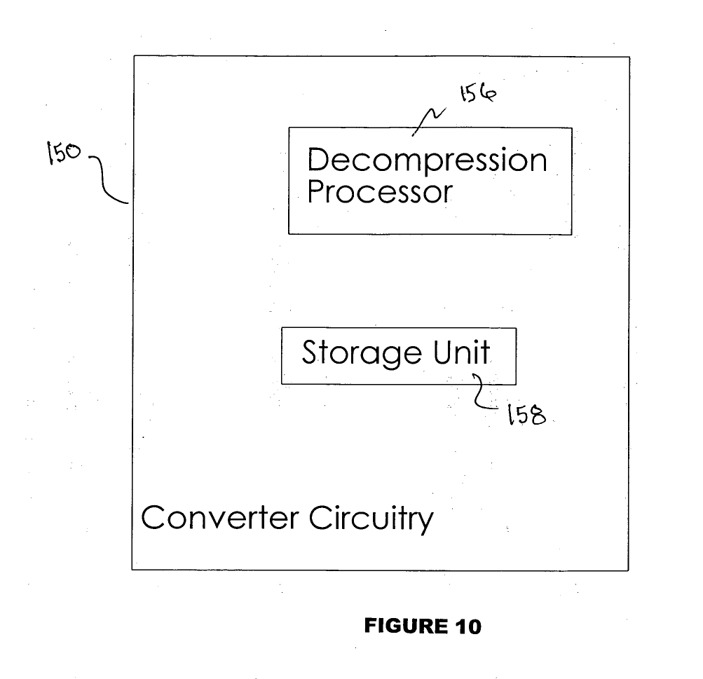

As best understood with reference to FIGS. 4A, 4B, 7, and 10, the converter 140 is remote from the image transmission device 110 and has circuitry 150 to selectively connect a data output port 6a of the second communications device 6 to a data input port (not shown) of the display 8 for transferring the data from the second communications device 6 to the display 8. The converter 140 may include means 156 for decompressing the data and a storage unit 158 for storing the data. The circuitry 150 is preferably in electrical communication with a power source 7 for energizing the circuitry 150, as shown in FIG. 7.

In use, the first communications device 2 may be secured to the cradle first area 112a of the image transmission device 110 by utilizing the securing means 114. The cradle 112 may be attached to the camera 4 by the attachment mechanism 116, and the cradle 112 may be attached to the tripod by mating the tripod attachment bolt with the cradle opening 119. The circuitry 122 connects the camera data output port 4a to the data input port 2a of the first communications device 2. More particularly, the first electrical cord connector 122a is attached to the camera output port 4a, and the second electrical cord connector 124a is attached to the first communications device data input port 2a. The converter circuitry 150 connects the data output port 6a of the second communications device 6 to the data input port of the display 8.

Data is transferred from the camera 4 to the first transmission device 2 using the image transmission device circuitry 120. The data may be compressed by the compressing means 126 before reaching the first transmission device 2. After reaching the first transmission device 2, the data is transferred from the first communications device 2 to the second communications device 6 using known data-transmission methods, such as cellular technology. Upon reaching the second communications device 6, the data is transferred to the display 8 by the converter device circuitry 150. Before the data reaches the display 8, the decompressing means 156 may decompress the data. Further, the converter storage unit 158 may store the data for later viewing.

The additional circuitry 130 of the image transmission device 110 may be connected to the power source 136, the camera power input port 4c, and the first communications device power input port 2b. The user may then selectively power the camera 4 and the first communications device 2 from the power source 136.

It is understood that while certain forms of this invention have been illustrated and described, it is not limited thereto except insofar as such limitations are included in the following claims and allowable functional equivalents thereof.

What is claimed is as follows:

1. An image transmission device for use with a mobile communications device and a video recorder, said image transmission device comprising:
a cradle having a first area for receiving the communications device and means for securing the communications device to said cradle first area; and
circuitry to selectively connect a data output port of the video recorder to a data input port of the communications device for transferring data from the video recorder to the communications device.

2. The image transmission device as in claim 1, further comprising means housed in said cradle for compressing the data.

3. The image transmission device as in claim 1, further comprising a processor housed inside said cradle and electrically connected to said circuitry, said processor including software for compressing the data transferred from the video recorder data output port and transferring the compressed data to the communications device data input port.

4. The image transmission device as in claim 1, wherein said means for securing the communications device includes a plurality of oppositely disposed walls being inwardly-biased for securing respective communications devices of various sizes.

5. The image transmission device as in claim 1, further comprising an attachment mechanism connected to said cradle for releasably attaching said cradle to the video recorder.

6. The image transmission device as in claim 5, wherein:
the video recorder defines a threaded opening; and
said attachment mechanism is a threaded bolt having a configuration complementary to a configuration of the video recorder threaded opening.

7. The image transmission device as in claim 5, wherein said cradle defines an opening having a configuration complementary to a configuration of a tripod attachment bolt for releasably attaching said cradle to a tripod.

8. The image transmission device as in claim 5, further comprising a second attachment mechanism connected to said cradle for releasably attaching said cradle to a tripod.

9. The image transmission device as in claim 1, wherein said circuitry comprises:
a first electrical cord extending from said cradle and having a connector compatible with the video recorder data output port; and
a second electrical cord extending from said cradle and having a connector compatible with the communications device data input port.

10. The image transmission device as in claim 1, further comprising additional circuitry in selective communication with a power source, a power input port of the video recorder, and a power input port of the communications device for selectively powering the video recorder and the communications device, respectively.

11. The image transmission device as in claim 10, wherein the power source is a battery positioned in said cradle.

12. The image transmission device as in claim 1, wherein the communications device is a cellular telephone.

13. An image transmission system for use with a digital camera, a first mobile communications device, a second mobile communications device, and a display, said system comprising:
an image transmission device comprising:
a cradle having a first area for receiving the first communications device and means for securing the first communications device to said cradle first area;
circuitry to selectively connect a data output port of the digital camera to a data input port of the first communications device for transferring data from the digital camera to the first communications device;
a converter device remote from said image transmission device, said converter device having circuitry to selectively connect a data output port of the second communications device to a data input port of the display for transferring the data from the second communications device to the display.

14. The system as in claim 13, wherein said image transmission device includes an attachment mechanism connected to said cradle for releasably attaching said cradle to the digital camera.

15. The system as in claim 14, wherein said image transmission device includes a second attachment mechanism connected to said cradle for releasably attaching said cradle to a tripod.

16. The system as in claim 13, wherein:
said image transmission device includes means housed inside said cradle for compressing the data;
said converter device includes means for decompressing the data; and
said converter device includes a storage unit for storing the data.

17. The system as in claim 13, wherein said image transmission device includes additional circuitry in selective communication with a power source, a power input port of the digital camera, and a power input port of the first communications device for selectively powering the digital camera and the first communications device, respectively.

18. A method for transmitting images from a user-supplied digital camera to a remote location using a first mobile communications device for viewing the transmitted images on a display, said method comprising:
providing an image transmission device comprising:
a cradle having a first area for receiving the first communications device and means for securing the first communications device to said cradle first area;
circuitry to selectively connect a data output port of the digital camera to a data input port of the first communications device for transferring data from the digital camera to the first communications device;
securing the first communications device to said cradle first area;
providing a second mobile communications device remote from the first communications device for communication with the first mobile communications device;
providing a converter device having circuitry to selectively connect a data output port of the second communications device to a data input port of the display for transferring the data from the second communications device to the display;
transferring the data from the digital camera to the first communications device using said image transmission device circuitry;
transferring the data from the first communications device to the second communications device; and
transferring the data from the second communications device to the display using said converter device circuitry.

19. The method as in claim 18, wherein:
said image transmission device includes means for compressing the data, said means for compressing the data being housed inside said cradle;
said converter device includes means for decompressing the data;
said image transmission device includes additional circuitry in selective communication with a power source, a power input port of the digital camera, and a power input port of the first communications device for selectively powering the digital camera and the first communications device, respectively;
said method further comprises:
compressing the data using the means for compressing the data;
decompressing the data using the means for decompressing the data;
selectively powering the digital camera and the first communications device, respectively, from the image transmission device additional circuitry in communication with the power source.

20. The method as in claim 19, wherein:
said image transmission device includes an attachment mechanism connected to said cradle for releasably attaching said cradle to the digital camera;
said image transmission device cradle defines an opening having a configuration complementary to a configuration of a tripod attachment bolt for releasably attaching said cradle to a tripod;
said method further comprises:
attaching said cradle to the digital camera using said attachment mechanism;
attaching said cradle to the tripod by mating the tripod attachment bolt with said cradle opening.
